(19) United States
(12) Patent Application Publication
(10) Pub. No.: US 2018/0311108 A1
(43) Pub. Date: Nov. 1, 2018

(54) PILL COATING APPARATUS AND METHOD

(71) Applicant: Bryan W. Nappi, Las Vegas, NV (US)

(72) Inventor: Bryan W. Nappi, Las Vegas, NV (US)

(21) Appl. No.: 15/666,752

(22) Filed: Aug. 2, 2017

Related U.S. Application Data
(60) Provisional application No. 62/491,063, filed on Apr. 27, 2017.

(51) Int. Cl. A61J 3/00; A61J 7/00

(52) U.S. Cl. CPC A61J 3/005; A61J 7/0046

(57) ABSTRACT

A system for administering tablets, capsules, caplets, nutritional supplements, pills, and the like includes a vessel having a container and cap, with intermediate closure assembly selectively permitting passage of a liquid coating (oil) therebetween. Pills between the closure (valve) and cap are coated by tilting the closed vessel while the cap is sealed on the container. When the vessel is upright, the coating liquid drains back into the container. Removal of the cap closes (seals) the closure assembly against escape of liquid from the container. A user may then pour a pill or pills from the basket directly into the mouth without touching fingers to the coating thereon. Oils and water-based liquids in the mouth and esophagus repel, so pills slide down, making swallowing easier.

### RELATED APPLICATIONS

This application claims the benefit of U.S. Provisional Patent Application Ser. No. 62/491,063, filed Apr. 27, 2017, which is hereby incorporated by reference in its entirety.

### BACKGROUND

### Field of the Invention

This invention relates to medicaments such as pills, capsules, tablets, and the like and, more particularly, to novel systems and methods for coating pills, tablets, and capsules for easier swallowing.

### Background Art

Manufacturers and providers of medicines and nutritional supplements administered as a solid or encapsulated form are familiar with the expression of “pill fatigue.” Pill fatigue is more than a mental or emotional response to administering multiple pills or capsules, including tablets and the like, several times per day. The mouth and esophagus of a user are moist. However, mucosal membranes may also have an adhesive quality when presented with a dry, moisture-absorbing medicament or nutritional supplement. Users tire of the difficulty of swallowing multiple “pills.” Moreover, when administered multiple times per day, a drink of water may not be readily available at some location remote from home or work.

Some users have more difficulty swallowing than others. In particular, pills, tablets, capsules, caplets, all referring to hereafter as “pills,” may have coatings to make them more flavorful, more slippery, to cause a timed release, or the like. These treatments sometimes help. Other times, a dry pill, or even a hard-coated pill may stick in a throat, esophagus, or mouth of a user. What is needed is a more immediate assistance to assure that pills are easily swallowed during administration, and do not cause discomfort, gagging, choking, stoppage along the introductory alimentary tract, or the like. Otherwise, the actual danger, discomfort, ineffectiveness, or some combination thereof inhibit compliance with recommended dosing.

### BRIEF SUMMARY OF THE INVENTION

In view of the foregoing, in accordance with the invention as embodied and broadly described herein, a method and apparatus are disclosed in one embodiment of the present invention as including a system including a vessel, made up of a container, cap, and internal closure. The container is filled with a pleasantly flavored oil, selectively sealed by the closure assembly and cap. A medicament (discrete, solid; pill, tablet, capsule, caplet, etc., all hereinafter “pill”) fits between the cap and the valved closure assembly, and the closure assembly fits in or on the container. The flavored oil in the container acts as a coating material on the medicament (pill).

The closure assembly renders the coating material temporarily accessible or inaccessible to a medicament placed between the cap and the closure assembly. The cap, when threading on to the vessel, moves a sealing portion of the closure assembly to an open position in order to expose the medicament (pill) to the liquid coating material.

In general, the container is sealed and a variety of attachment mechanisms, including threads, interference fits, compression fits, detents, or the like may work to secure the closure assembly into the mouth of the container. The cap, fitted to depress a plunger, lever, or actuator portion of the closure assembly, opens a valve permitting coating liquid to pass from a lower portion of the container, through the closure assembly, while temporarily opened. In this liquid-passing configuration, oil enters into the region of the pill, between the closure assembly and the cap. The medicament contained therein is thus coated, sprinkled, immersed, or otherwise exposed to the coating liquid.

The coating liquid may contain any desired portion of a carrier oil. The oil may be a vegetable oil or mineral oil selected. Meanwhile, a flavoring, which may be formed from a particular food, herb, essential oil, fruit, or the like may be dissolved in the carrier to form the liquid. Certain excipients, such as alcohol, surfactants, or other materials may assist in altering viscosity, adhesion, taste, or other physical properties of the flavoring or the carrier when added to the coating liquid.

In certain embodiments, a container may include a bottom, a wall, and threads inside, outside or elsewhere near a neck or opening. A rim of the container may be fitted with seals to assure that the coating liquid does not escape at any time.

The closure assembly may include an insert that holds or contains threads or other securement mechanisms to secure the insert in the opening at the neck of a container. Meanwhile, the insert may include a rim portion containing threads to engage the cap, as well as a central guide portion that will contain and guide a shaft or pedestal. The shaft may support a basket (holder) between the shaft and the cap in order to secure and support a medicament (pill, whether medicine based or nutritional supplement based), to be coated.

A rim on the insert may provide sufficient axial bearing length to secure the insert into the opening of the container. The guide may have sufficient axial bearing length to secure and guide the shaft as it passes back and forth therethrough in a vertical (nominally), axial direction. Typically, the insert will have some form of a seal therebelow. The seal may have a backer acting as an anvil or core to move the seal with the shaft. The shaft is pushed up and down by a spring or bias element pushing the shaft upward when the cap is off, and the cap pushing the shaft downward when threaded on.

Actually, a basket at a top end of the shaft may capture a spring or bias element between the basket thereabove, and the insert therebelow. These alternately bias the basket upward in the absence of the cap, and push the basket and shaft downward in response to contact from the cap being placed on and threaded down onto the opening or neck of the container.

The basket will typically be porous, perhaps even having a void fraction greater than fifty percent. In fact, the maximum void fraction is to be sought, within the bounds of structural integrity. Thus, the basket may be swept with the coating liquid coming from the container when the cap is on, holding or urging the basket, shaft, and seal, with its associated backer, downward. This places the seal away from the opening of the insert into the container. Thus, oil may pass through the opening in the insert to surround or otherwise coat a pill captured in the basket between the insert and the cap.

Upon standing the container upright on its base or bottom end, any excess coating liquid may drain back from the basket. It passes through the perforated or sieved insert. Passing the seal and backer the unused oil arrives back at the bulk liquid coating in the container. Upon removal of the cap, the basket moves upward under the bias provided by the spring or bias element.

This same force applied by the bias element or spring thus drives the shaft upward. The shaft draws the backer upward, carrying the seal into contact with the insert. The insert closes all apertures between the container and the insert.

At this point, with the coating oil liquid having drained away, except for what is adhered more-or-less securely to the pill and other components, a user may simply toss the pills into the mouth from the basket, as from a cup. No mess, no touching of the pills, no soiling of the hands with the coating liquid, or the like is required.

In one embodiment, the basket may be made particularly shallow, and the moveable basket, shaft, backer, seal, and the like may be dispensed with. In this embodiment, the oil path would always be open from container to cap, even through the insert. With a sufficiently shallow rim on the basket, a user may extract with fingertips, or with the lips a pill resting in the basket.

The basket in a movable configuration may include a floor, which is preferably highly perforated, and may be made of metal screen, plastic, or the like. In certain embodiments, components contained by the closure assembly may be oleo-phobic in order to reduce the tenancy of an oil-based coating liquid to adhere thereto. This may assist in draining. However, it may present certain problems with passing through comparatively smaller openings such as grills, grids, screens, and the like to gain access to a pill in the basket.

In certain embodiments, the basket may include a floor that substantially covers the opening of the container, almost coincident with the insert. A rim may be selected to have a height sufficient to capture a pill or multiple pills. Moreover, the rim may be sufficiently high to establish a contact with the cap. This may likewise establish a precise movement and distance downward as the cap is threaded onto the container. It will push the basket, shaft, seal, and backer downward to expose the pill in the basket to a coating liquid.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a side, elevation, cross-sectional view of one embodiment of a system in accordance with the invention, the applicator being illustrated in exploded view with alternative shapes of pills, and containers for the liquid constituents illustrated;

FIG. 2 is a side, elevation, cross-sectional view of an alternative embodiment of a system in accordance with the invention, illustrating a cap over a closure assembly, over a container;

FIG. 3 is an exploded view of one embodiment of a system in accordance with the invention illustrating alternative configurations of a cap, alternative configurations of a closure assembly, and alternative configurations of a container;

FIG. 4 is a perspective view of one embodiment of a cap, cut away to reveal a basket, pedestal, and insert along with the associated seal and backer for applying the seal to the insert, at the urging of a spring driving the basket or urging the basket away from the insert;

FIG. 5 is a side, elevation, cross-sectional view of one alternative embodiment of an insert, with a seal therebelow, and a basket and pedestal (shaft) being urged away from the insert by a spring resting on a guide portion of the insert and pushing against the basket;

FIG. 6 is a top plan view of one alternative embodiment of an insert;

FIG. 7 is a top plan view of an embodiment of a basket;

FIG. 8 is a bottom plan view of an alternative embodiment of a basket;

FIG. 9 is a side, elevation, cross-sectional view of an embodiment of a system relying on a comparatively larger opening and seal below a pedestal and basket urged downward by a cap on a container;

FIG. 10 is a side, elevation, cross-sectional view of an alternative embodiment of a system in accordance with the invention in which the bottle or container is provided with seals, and the insert is actually threaded outside the container, with the cap being an internal plug sealed to prevent escape of liquids, such as oils, and configured to minimize leakage or spilling of oil by draining back into the container;

FIG. 11 is a side, elevation, cross-sectional view of an alternative embodiment of a closure assembly, using a smaller poppet valve as a seal in an insert supporting a pedestal and basket below a cap (lid);

FIG. 12 is a schematic block diagram of a process of making and using a system in accordance with the invention;

FIG. 13 is a front, elevation, cross-sectional view of an alternative embodiment of a system in accordance with the invention illustrating a shaft connected to a valve mechanism and positioned to be depressed by threading a cap on the container, thereby opening the valve biased upward by a spring therebelow in the container; and

FIG. 14 is a front, elevation, cross-sectional view of yet another alternative embodiment in which the shaft descends from the cap to depress the seal, and open it against the spring therebelow.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

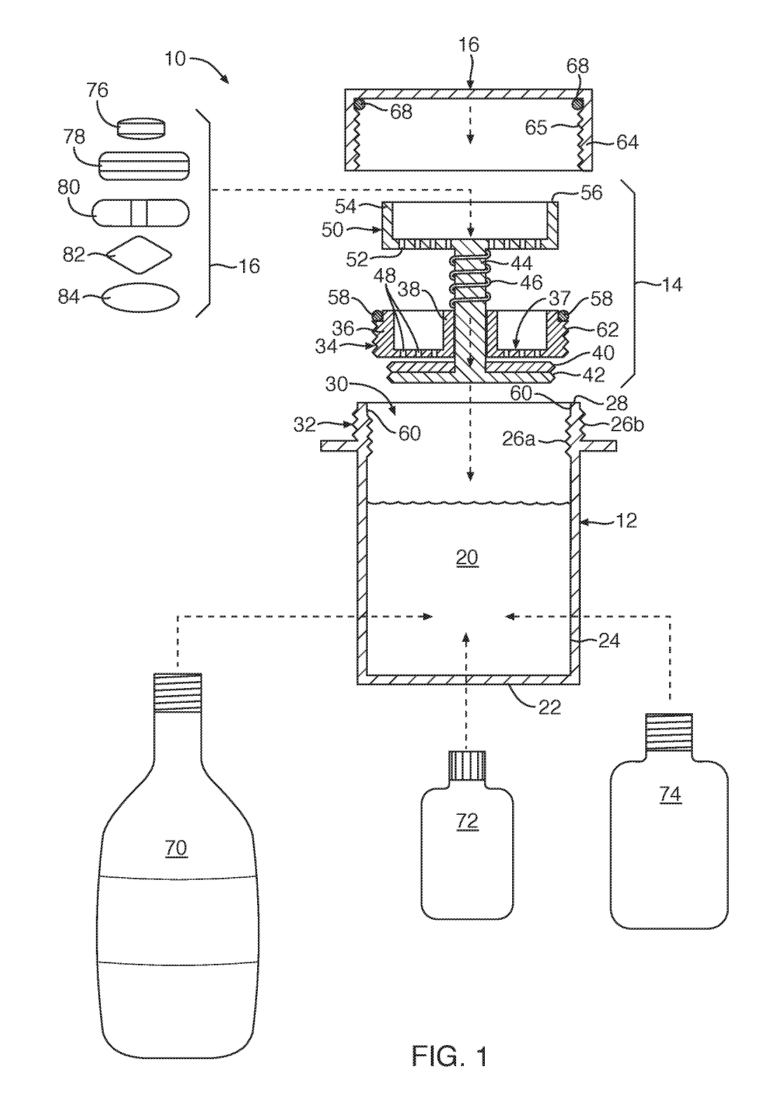

Referring to FIG. 1, while referring to FIGS. 1 through 14, generally, a system 10 in accordance with the invention may begin with a container 12. The container 12 may be any of numerous varieties available. For example, the container 12 may be formed of a polymer, such as any commonly used plastic, glass, composite material, an elastomeric polymer, such as rubber or the like, and may be rigid or solid.

In certain embodiments, the container 12 may be somewhat flexible. The walls 24 of the container 12 need not be particularly rigid. Polymers such as polyethylene, polypropylene, and the like may form the container 12.

The system 10 benefits from a closure assembly 14 that includes various components. The closure assembly 14 may be made comparatively simple or comparatively complex. Of course, complexity often provides additional benefits, with the burden of additional costs, assembly, and so forth.

Nevertheless, in one contemplated embodiment, a closure 14 may be sealed above by a cap 16. The cap 16 serves to seal the closure assembly 14 into the container 12. The closure assembly 14 may actually be intermediate the container 12 and the cap 16. In other embodiments, the closure assembly 14 may be completely within the container 12, and the cap 16 may seal the container 12, thus sealing the closure assembly 14 therewithin.

Typically, a pill 18 may be placed in the closure assembly 14, at the top thereof or nearby in order to be administered to a user. Typically, a pill may be selected from a tablet, caplet, capsule, or other pill-like material. In fact, a pill may actually be a nutritional supplement rather than a medicament, may be an over-the-counter medicine or drug, or may be a prescription medicine. Typically, a pill 18 will have a solid outer surface, whether hard or flexible. The pill 18 may include some type of a coating, such as an enteric coating, a flavored coating, a colored coating, or the like. In alternative embodiments, a pill 18 may simply be a dry, compacted powder that has been solidified by means of an excipient such as a binder, a release, or both making effective a construction or manufacture of a pill 18.

One purpose of the container 12 is to secure, carry, contain, and otherwise make accessible a coating 20. The coating 20 differs from a pill coating that would normally be found on a pill 18 provided by a vendor. The coating 20 is temporary, and is a liquid 20. In certain embodiments, powders may be used for a coating 20, but one currently contemplated embodiment relies on a liquid coating 20.

In general, a container 12 may have a bottom 22 that is sufficiently flat that it will stand the container 12 upright. This is a valuable function of the bottom 22, in order to assure that the coating material 20 will drain from the closure assembly 14 back into the container 12 just before a pill 18 is administered. For example, a user need not touch a pill 18 with fingers, and thus need not contact the coating 20 with other than the mouth of a user.

For example, just before administering a pill 18, a user may actually tip the container 12, with the cap 16 attached thereto, upside down in order to pour the coating 20 through the closure assembly 14, in an open configuration, into the cap 16. Ultimately, the purpose of pouring the coating 20 into the cap 16 or the interior of the cap 16 is to 36 coat the pill 18. By pill 18 is meant any of the tablets, capsules, caplets, pills, or other medicaments, nutritional supplements, or the like to be administered. A single pill 18 herein represents one or more (multiple) pills 18 at once, all supported in the closure assembly 14 for coating by the coating material 20.

Thus, the bottom 22 is useful to stand the container 12 upright, with the cap 16 at the upper extreme thereof and the bottom 22 at the lowest extreme. Thereby, the pill 18 may drain any excess coating material 20 therefrom, while the closure assembly 14 may also drain back into the container 12 any excess coating 20.

A wall 24 surrounds the bottom 22 and forms the remainder of the container 12. The wall 24 may be any shape desired, depending on function and aesthetics. For example, the wall 24 may be a single expanse forming a right circular cylinder for the container 12. In other embodiments, the shape of the wall 24 may be polygonal about a bottom 22 serving as a directrix of the wall shape 24. Simple rectangles, simple polygons, and the like may be formed. Moreover, the container 12 may be any suitable shape to be convenient, easily carried, structurally sound, and attractive. It may narrow to form a narrower neck at the opening thereof.

Referring to FIGS. 1 through 11, while continuing to refer generally to FIGS. 1 through 14, the wall 24 may be provided with threads 26a, 26b. The threads 26a may actually be in the side the container 12. For example, a rim 28 may form the uppermost extreme of the container 12, absent the cap 16. Meanwhile, the rim 28 defines an opening 30 into the container 12.

Depending on the shape of the container 12, the opening 30 may be formed in, or as part of, a neck 32. A neck 32 may be comparatively long with respect to the overall dimensions of the container 12, comparatively short, or virtually absent. Nevertheless, at a minimum, one may consider the threads 26a, 26b to occur in a neck region 32 of a container 12.

As a practical matter, the closure assembly 14 may be connected to the opening 30 of the container 12 in any suitable manner. Any combination of seals, compression, threads 26, latches, or the like may be used to seal the closure assembly 14 against the opening 30 of the container 12. Corks, stoppers, male caps, female caps, double walled caps, ‘O’-ring seals, rims, borders, and the like may all be used to assure a liquid-proof seal between the closure assembly 14 and the container 12, as well as between the cap 16 and either the container 12, the closure 14, or both.

Typically, an insert 34 may fit inside the opening 30 of a container 12. However, in some of the illustrated embodiments, the insert 34 may actually be formed entirely as a female cap fitting over the outside of the wall 24 of the container 12.

Typically, a rim 36 and guide 38 will be formed in the insert 34. That is, as a practical matter, molding an insert 34 may be done in a simple two-part mold, in which each side is shaped to the mold cavity. Thus, a rim 36 may be formed at an outer perimeter of the insert 34, while a guide 38 may extend vertically away from a floor 37 of the insert 34.

For example, a seal 40 may provide the main seal 40 between the closure assembly 14 and the container 12. Thus, a seal 40 may include a backer 42 or core 42 that acts as an anvil 42 in order to urge the seal 40 to a regular position against the rim 36 (the lower end thereof), the shaft 44 or pedestal 44, and apertures 48 in the floor 37.

In operation, the insert 34 acts to form a partial barrier, being perforated thoroughly in order to rapidly pass coating liquid 20 from the region toward the cap 16, back through the insert 34, and into the bulk of the container 12 toward the bottom 22 thereof. To this end, many or large (comparatively speaking) apertures 48 may be formed in the insert 34 or the floor 37 thereof. Through that floor 37, and the center of the guide 38 will pass a shaft 44 or pedestal 44. On the top end of that shaft 44 or pedestal 44 is secured the basket 50, by means of threading, riveting, heat sealing, contiguous forming, other fasteners, homogenous molding, or the like. Thus, the basket 50 is connected to move axially with the shaft 44.

The shaft 44 may be surrounded by a spring 46 operating as a bias element 46. The bias element 46 pushing against the basket 50 atop the shaft 44 urges the basket 50 up and away from the floor 37 of the insert 34. The basket 50 itself also has a floor 52, thoroughly perforated, and perhaps of a grid, grille, screen, or the like. The larger the apertures in such a floor 52, the easier the liquid coating 20 may pass therethrough to regain the container 12.

On the other hand, smaller (comparatively speaking) apertures tend to hold liquids by surface tension, especially oils 20 as coatings 20. Thus, excess liquid coating 20 is desired to pass through the floor 52 of the basket 50, from the basket 50, from the shaft 44, and from the interior of the cap 16 in order to pass back through the open seal 40 and past the backer 42 into the container 12.

Referring to FIGS. 1 through 11, and to FIGS. 1 through 14, generally, the basket 50 operates by having the edge 56 of the rim 54 engage the cap 16. For example, the edge 56 of the rim 54 will typically be the highest location away from the floor 52 of the basket 50. A central post or the like could substitute to urge the basket 50 to follow the cap 16 downward, thus opening the seal 40 away from the insert 34.

However, as a practical matter, the rim 54 may serve to contain pills 18 within the basket 50 so that multiple pills 18 may be taken or administered at once. The rim 54 need not completely cover the pills 18 or accommodate their entire thickness or height within the cap 16, but pills 18 may be of various sizes.

Some nutritional supplements are on the order of half an inch long and more than a quarter inch in girth and more. Others may be tablets less than a quarter inch in diameter, and less than half that in thickness. Thus, in order to contain any and all pill sizes 18, the depth of the rim 54 from the edge 56 to the floor 52 of the basket 50 may be selected to be comparatively large or to fit the comparatively largest pills 18 contemplated.

In certain embodiments, the insert 34 may actually include an additional seal 58 fitted against a seat 60 in the container 12. For example, in the illustrated embodiment, a seal 58 such as an ‘O’-ring seal 58 may fit within a relief region provided in the insert 34. The threads 62 of the insert 34 pass into and engage with the threads 26a inside the neck 32 or opening 30 of the container 12. The seal 58 will eventually be brought to bear against the seat 60, sealing the insert 34 against the wall 24 of the container 12.

Thus, the liquid 20 cannot creep, if it is an oil-based liquid 20 through the threads engaged with the threads 26a of the container 12. Threads 26, 62, 65 must all have a certain tolerance or clearance. Liquids 20 operating as coatings 20 may be relied upon to creep. Sealing the insert 34 to the container 12, the cap 16 to the container 12, the closure assembly 14, or both, as well as sealing the floor 37 of the insert 34 are important.

The cap 16 may be formed to have a wall 64 engineered to fit inside or outside the opening 30 of the container 12. One advantage of an outside fit is simplicity in manufacture and use. To that end, the top 66 of the cap 16 may be provided with a seal 68 set in a proper relief region to operate against a corresponding rim 28 of the container 12. Thus, whether a face seal, an end seal, or a sliding surface seal, the seal 68 may contact the rim 28, or may sit opposite the seat 60 on the inside of the wall 24 of the container 12.

In operation, one can see how the threading of the threads 65 on the cap 16 against the outer threads 26b of the container 12 will draw the cap 16, and particularly the top 66 thereof down against the edge 56 of the basket 50. As the basket 50 contacts the top 66 of the cap 16, the basket 50 closes against the top 66, capturing the pills 18 therein. Meanwhile, urging by the top 66 of the cap 16 against the edge 56 of the basket 50, urges the basket 50 to move against the bias 46 or spring 46.

Accordingly, the shaft 44 is depressed down into the container 12 opening the seal 40 sealing the floor 37 of the insert 34. Upon this urging the seal 40 to open, the liquid coating 20 will gain access to the basket 50 whenever the container 12 is tilted or up ended sufficiently. Thus, opening and closing the system 10 should always be done with the container 12 in an upright position. Granting sufficient delay time will let all the liquid 20 that will drain from the basket 50, through the insert 34, and into the reservoir 12 that is the container 12.

The liquid 20 may be formed of one or more materials. It has been found effective to use a vegetable oil, of suitable mild flavor as the carrier 70. For example, olive oil has been found to be highly suitable. Other vegetable oils, including safflower, canola, and the like may be used. In some embodiments, mineral oil may be used. Thus, the carrier 70 is selected to accommodate a flavor 72.

The flavor 72 need not be required. Moreover, the flavor 72 is typically in a liquid form, such as an essential oil, an extract, or the like. Extracts 72 as selected flavors 72 may require excipients 74, such as an alcohol 74 in order to dissolve the flavor component 72 into an infusion of the excipient 74. Thereafter, the flavor 72 thus contained in the excipient 74, may then be added to the carrier 70 in an appropriate proportion. The flavor 72 may be embodied as a tincture or infusion within an excipient 74. Other excipients 74 may be added for various purposes. Those purposes may include medicinal, comfort, aesthetic, or other purposes.

Flavors 72 may be mild or comparatively strong with respect to the carrier 70. In some embodiments, a vegetable oil, such as olive oil 70 may be mixed directly with an essential oil, such as a citrus oil. Lemon, lime, orange, and the like have essential oils with comparatively strong flavors 72, and “a little will go a long way.” On the other hand, certain vegetables have flavoring 72 that may dissolve in oil or water. Most will also dissolve in alcohols. Spices, such as cinnamon, cloves, and others, referred to as “sweet spices,” may be used with an excipient 74 such as an alcohol in order to dilute them to the proper proportions in order to mix with the carrier 70.

Alternative excipients 74 may be selected to alter viscosity. On the one hand, viscosity provides the ability of the coating 20 to remain on the outside of a pill 18. On the other hand, that adhesion may be due to another function. In order to drain the coating 20 back from the basket 50, and through the insert 34, a low viscosity is preferred. Thus, the carrier 70, the flavor 72, excipients 74, may be selected in concert to provide suitable coating, suitable water-insolubility, in order to aid in swallowing the pills 18, while matching a viscosity and adhesion functionality desired.

Thus, the pills 18 may be selected from solid, dried tablets 76, or caplets 78, which are effectively formed similarly to tablets 76, but are typically larger, and mimic the shape of a capsule 80. The capsules 80 are typically formed of water-soluble and easily digestible natural material, such as gelatin. Gelatin forms a hard, natural polymer shell, which quickly dissolves in the digestive tract. Meanwhile, other shapes of pills 82 may be shaped for a particular reason, typically to identify a manufacturer, or to identify the nature of the pill 82. Meanwhile, other pills 84 may be formed of solids, sealed liquids, having hard surfaces, soft surfaces, or the like.

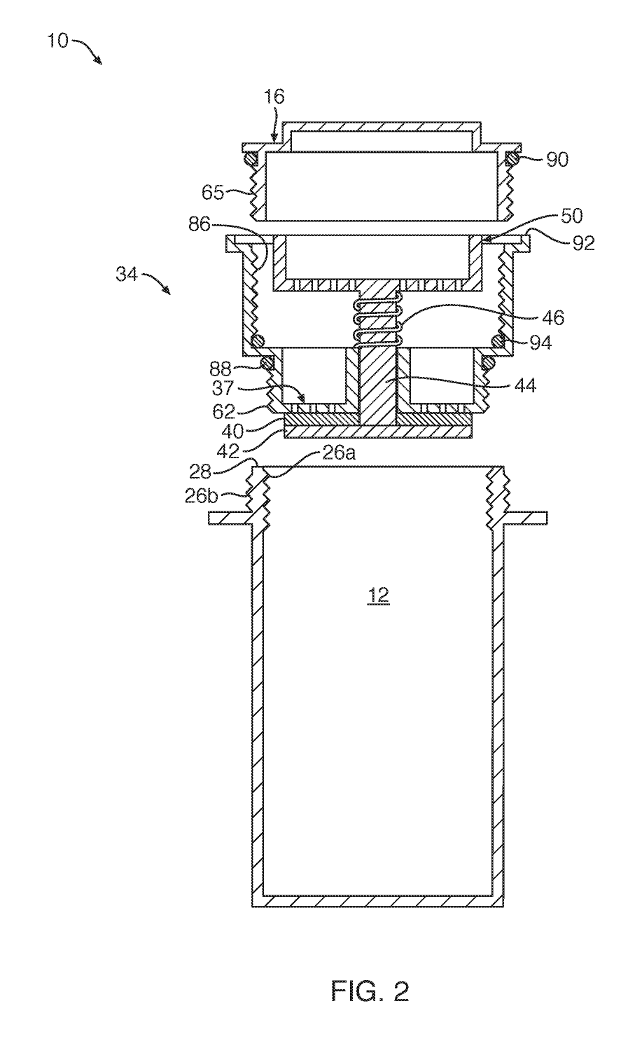

Referring to FIG. 2, while continuing to refer generally to FIGS. 1 through 14, in one embodiment, a system 10 in accordance with the invention may include a conventional, safety-type (childproof), pill bottle as the container 12. Meanwhile, the insert 34 may be formed from a bi-modal cap 34 such as is used on dry pill bottles. By suitable provision of an additional cap 16, formed to fit within the insert 34, the basket 50 may be depressed with the shaft 44 against the spring 46.

In this embodiment, the insert 34 is formed by using the male end of the cap structure 16, modified to provide the porous floor 37 of the insert 34, as well as the guide 38. Thus, the seal 40 and backer 42 operate in a modified version of a cap 16 operating as an insert 34. Meanwhile, the cap 16 then has a male thread 65 that fits within the corresponding threads 86 formed in the insert 34. Thus, the threads 62 of the insert 34 thread into the threads 26a of the container 12.

The threads 26b are unused. The threads 62 and the threads 26a may be sealed by a suitable seal 88 urged against the rim 28 of the container 12 by the engagement of the mutual threads 26a, 62. Similarly, the cap 16 may thread with the threads 65 against the threads 86, in order to urge the cap 16 to seal with the ‘O’-ring or other seal 90 against the upper lip 92 of the insert 34.

Alternatively, or in addition, the bottom edge of the cap 16 may also seat against a seal 94 inside the insert 34. Otherwise, the system 10 of FIG. 2 operates as described with respect to FIG. 1 and the other figures.

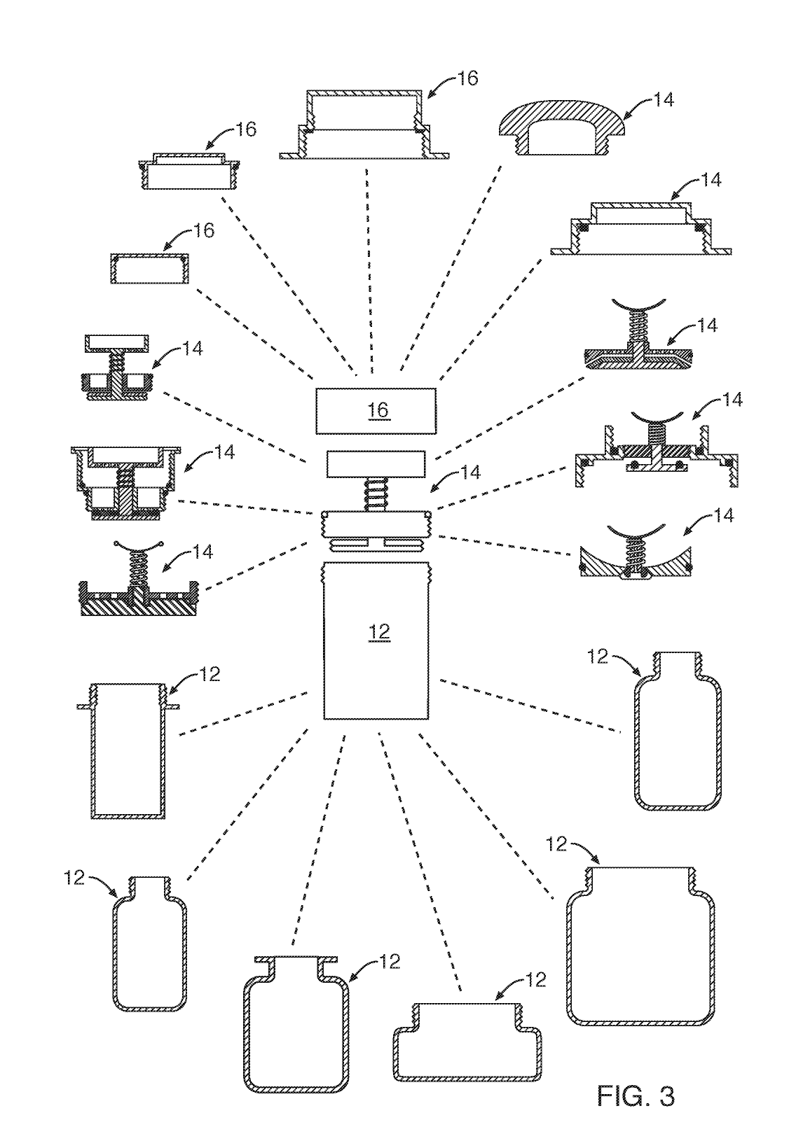

Referring to FIG. 3, as a practical matter, various types of caps 16 may be selected. The type of cap 16 may depend on the shape of the container 12. Meanwhile, the shape of the container 12 may be selected from any of several suitable, commercially available containers 12. It may be custom made or slightly modified to add threads or remove threads as needed to engage the insert 34. In fact, male threads, female threads, stoppers, and double walled seals may capture a rim 28 of the container 12 in order to effect a seal.

Various other types of ‘O’-rings or other seals may be used. Similarly, the insert 34 may be any of several types having a comparatively larger seal 40 against the insert 34, or a comparatively small poppet valve.

The time required for obtaining liquid coating 20 inside the cap region 16 to coat pills 18 in the basket 50 is a limit. Also, time to drain that same excess coating liquid 20 back into the container 12 is required. Thus, one may engineer a system that provides the suitable time desired, as well as the operation, and a suitable coating 20 for the pills 18 to be administered.

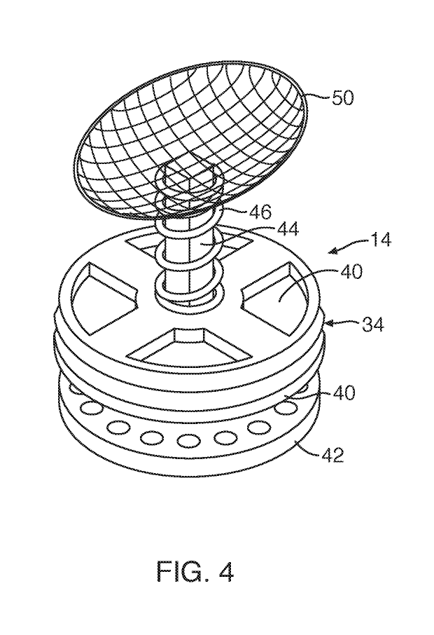

Referring to FIG. 4, the perspective view illustrates one embodiment of the apertures 48 in the insert 34. Meanwhile, the support or backer 42 for the seal 40 is illustrated in this embodiment.

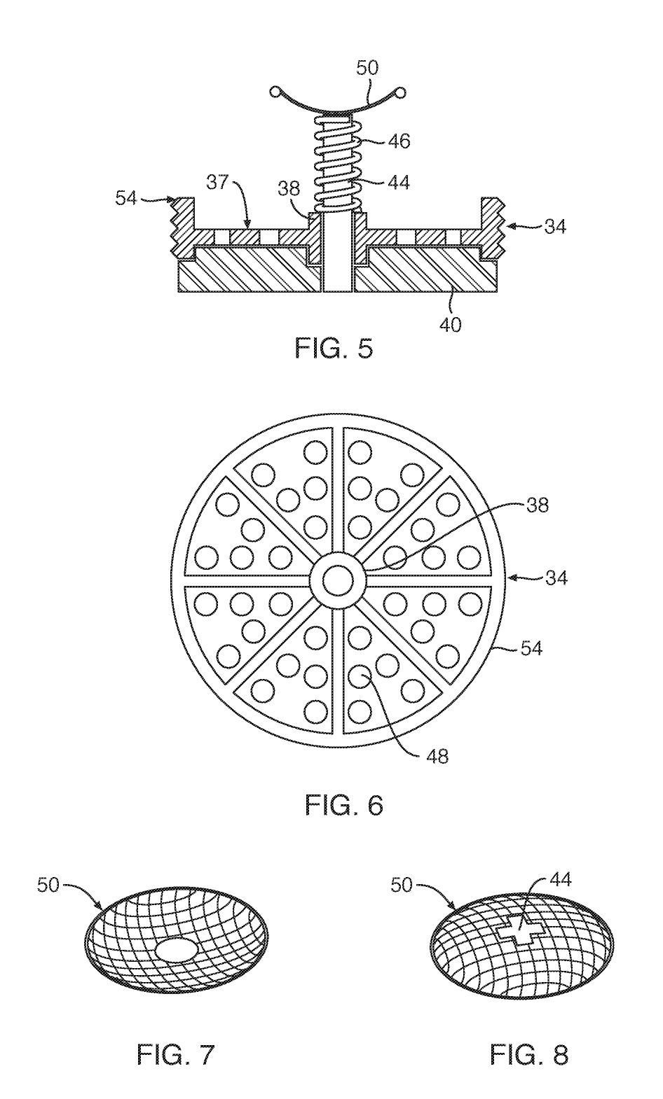

Referring to FIGS. 5 through 8, a basket 50 may operate against a spring 46 to drive a shaft 44 down through a guide 38 in the floor 37 of a rim 54 of an insert 34. The seal 40 may be of any suitable shape, and may be sufficiently robust or stiff to not require a backer 42. The benefit of a backer 42 is that the seal 40 may be made of a sufficiently soft and thin material to be more compliant (requiring a lighter spring force) with the backer 42 and against the floor 37 of the insert 34.

Referring to FIG. 6, a top plan view of an insert 34 illustrates one embodiment in which extensive perforations may pass through an insert 34. The apertures 48 may be small or large, and may actually be configured as “pie-shaped” gaps between spokes of a wheel as the insert 34.

Referring to FIG. 7, the basket 50 may typically be a very porous structure with a central region formed to receive securely the shaft 44.

Referring to FIG. 8, the shaft 44, may be round, cylindrical, polygonal, cruciform, or otherwise shaped. Depending on the path for material to pass back through the floor 37 of the insert 34, additional space between the guide 38 and the shaft 44 may be provided for the basket 50.

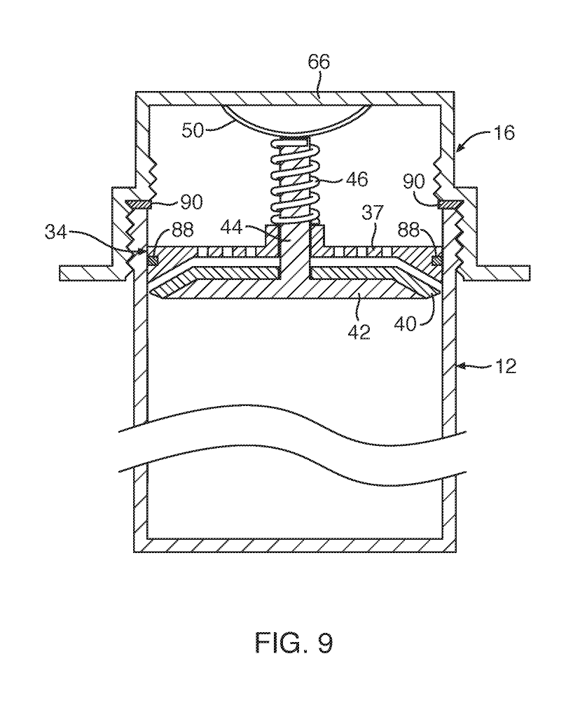

Referring to FIG. 9, in one alternative embodiment, the container 12 is illustrated with a cap 16 installed thereon sufficiently compressing the spring 46 and the shaft 44 to place the basket 50 against the top 66 of the cap 16. Meanwhile, this spaces the backer 42 and the seal 40 in a position away from the floor 37 of the insert 34. In this embodiment, the insert 34 is threaded into the opening 30 of the container 12. Meanwhile, the cap 16 is threaded to the outer surface of the container 12.

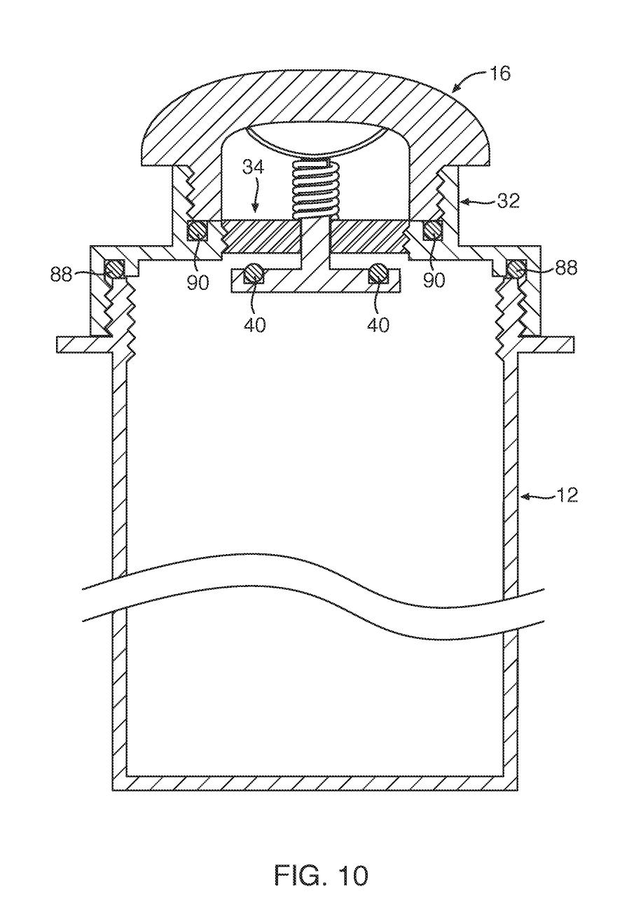

Referring to FIG. 10, in one embodiment, multiple seals 40, 88, 90 may be provided. In this embodiment, the cap 16 is a male cap threaded to fit inside the neck 32 of the container 12. The insert 34 also fits inside the neck 32 of the container 12. Thus, the insert 34, and the cap 16 may both thread into the neck 32 of the container 12.

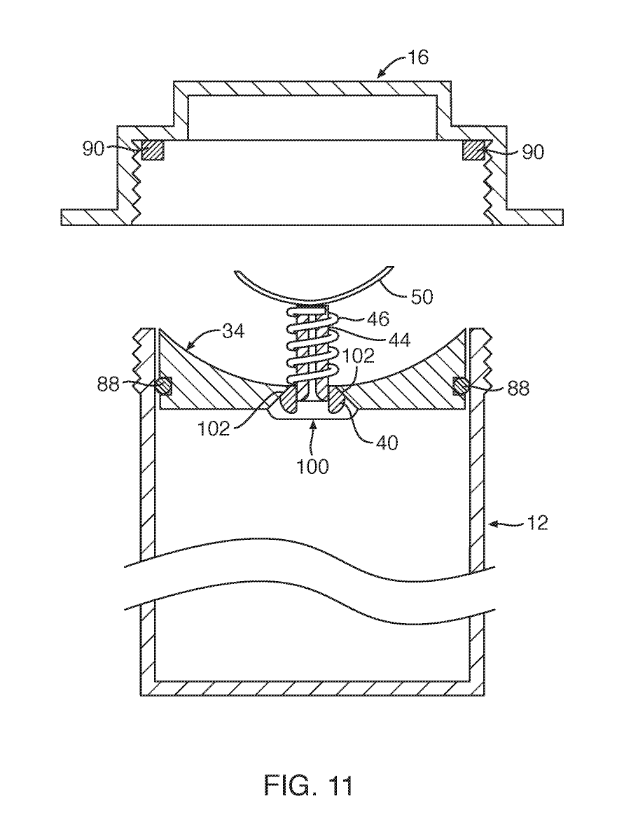

Referring to FIG. 11, in one embodiment, a simple poppet valve 30 may be used with a central opening 94. The poppet valve 100 may include a seal 40 such as an ‘O’-ring that fits against a seat 102. In this embodiment, the entire shape of the insert 34 may be calculated to drain the liquid coating 30 toward the opening 94 between the poppet valve 100 and the seat 102. In this embodiment, seals 88 between the insert 34 and the wall 24 of the container 12 may provide liquid proofing.

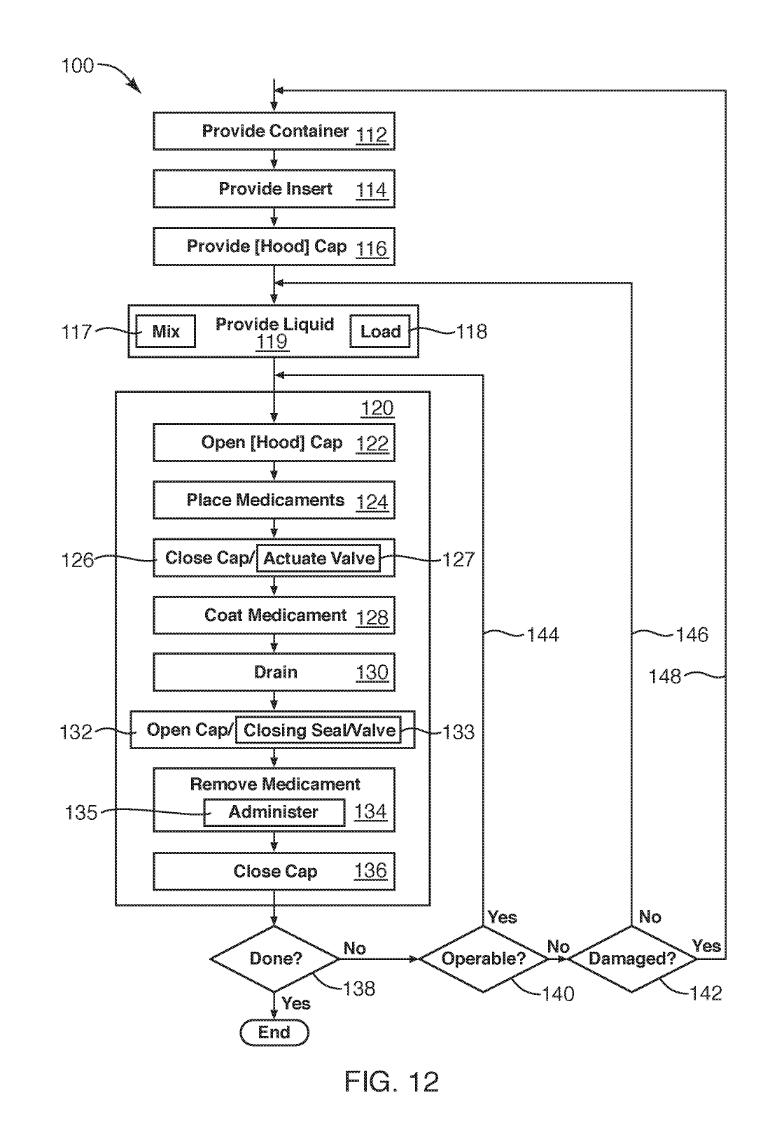

Referring to FIG. 12, in one embodiment of an apparatus and method in accordance with the invention, a system 10 may be assembled and used in accordance with a process 101. For example, the process 101 may begin with providing 112 a container 12. Providing 112 may include purchase, manufacturing, selecting, and otherwise deciding what is needed, what size, what shape, what attachment mechanisms, such as threading, and the like in order to accommodate a proper insert 34.

Providing 114 an insert 34 may include selecting, manufacturing, assembling, or otherwise providing an insert 34 suitable to fit securely within the opening 30 or neck 32 of a container 12 selected. Providing 116 a cap 16 or hood 16 may involve an entirely removable cap 16, or a simple, openable flap 16, door 16, panel 16, or the like. In some embodiments, a highly biased (spring loaded) flip-top closure on the top of the insert 34 may actually provide a suitable cap 16. Nevertheless, the cap 16 may be separately secured to and removable from the container 12.

Providing 119 a liquid 20 or liquid coating 20 may include mixing 117 as well as loading 118 the liquid 20 into the container 12. On the one hand, providing 119 may include purchasing a pre-mixed 117, liquid 20 that contains all the necessary carriers 70, flavors 72, excipients 74, and the like. Typically, a user may load 118 by pouring a liquid 20 up to a pre-determined fill mark on a transparent container 12.

The effective use 120 may include opening 122 the cap 16 and placing 124 pills 18 thereon. Thereafter, one may close 126 the cap 16, which will automatically actuate 127 the seal 40 or valve 40. Coating 128 may include rotating, shaking, or upending the container 12 to pass the coating liquid 20 from the bulk of the container 12 up into the interior of the cap 16. Thereafter, the container 12 should be set in a stable location in an upright position with the bottom 22 thereof on a solid, flat, level surface to drain 130.

Draining 120 will drain a certain amount of the liquid 20 away from the pill 18 contained in the basket 50, and will also drain most of the liquid coating 20 back from within the cap 16 through the insert 34, and into the bulk region of the container 12. At this point without further movement of the container 12, one may open 132 the cap 16.

This has the effect of closing 133 the seal 40 or valve 40 in the insert 34. At this point, with the seal 40 being completed closed 133, and the cap 16 being completely open 132, one may remove 134 the pill 18 by pouring the pills 18 into the mouth of a user. In other embodiments, or preferred actions, a user may simply toss off or toss in the pills 18 into the mouth with a quick wrist motion applied to the container 12.

Thereafter, one may close 136 the cap 16 with or without any pills 18 in the basket 50. In certain embodiments, the pills 18 may be carried around in the container 12 until ready to use. Then, one simply need drain 130 the cap region 16 and proceed with opening 132 and removing 134 or administering 135 the medicaments 18.

Thereafter, one may decide whether the process 101 is done 138. The test 138 is simply an acknowledgment that one is or is not done with the use of the system 10. If one is not done, then the test 140 determines whether the system 10 is still operable. If the system 10 is still operable, then the test 140 returns the process 101 back to the process 120.

If, on the other hand, the system 10 is no longer operable, then the test 140, with a negative return, passes to the test 142 whether the system 10 is damaged. If the system is not damaged, then the process 101 should return to providing 119 more liquid 20 into the container 12. If, on the other hand, the system 10 is damaged, then the process 101 should return 148 back to providing 112 a suitable, operational container 12. Thus, the return 144 refers to continued operation, whereas the return 146 returns to refill or provide 119 a refill of the coating liquid 20. The return 148 may actually return 148 the process 101 to beginning with a new container 12.

In an alternative embodiment, the insert 34 may be a solid containing a basket 50 on supports 110. The supports 110 are gapped to provide access to the basket 50. Meanwhile, the rim 54 of the basket 50 need not contact the top 66 of the cap 16. Rather, the content 30 or liquid 30 may be accessible at all times to the basket 50 and any pill 18 contained therein. In this embodiment, the rim 54 of the basket 50 merely needs to be close enough to the top 66 of the cap 16 to avoid losing the pill 18 down into the liquid 30.

In this embodiment, the process 101 proceeds almost the same, except that opening the cap 16 does not close a valve 40 or seal 40. Similarly, placing 126 the cap 16 on the container 12 does not actuate 127 a valve 40. This system is not as robust, but is still useful, and may solve the problem in a home environment, where the system 10 may simply sit on a bathroom counter or in a bathroom cabinet until used.

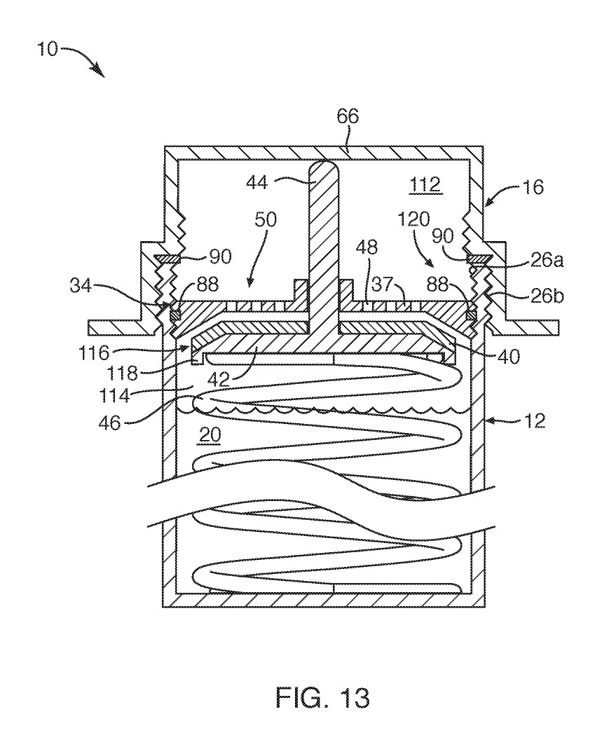

Referring to FIG. 13, while continuing to refer generally to FIGS. 1 through 14, in one alternative embodiment of a system 10 in accordance with the invention, the container 12 may be of any suitable length, and the bias spring 46 may be positioned within the container 12 directly, rather than as a part of the insert 34 in or near the neck 32. In this embodiment, the insert 34 may be set into the container 12 by any suitable mechanism.

For example, the insert 34 may thread into the container 12 on the threads 26a, not shown in detail here for clarity (see FIG. 2 for example). In the illustrated embodiment, the shaft 44 connects to the backer 42 that serves as the anvil 42 or support 42 for a much more flexible seal 40.

The seal 40 may be composed of a suitable elastomeric material, such as a typical gasket material, neoprene, Teflon™, silicone, or other natural or synthetic elastomeric polymer. The apertures 48 may be multiple and comparatively smaller, such as a grid work or screen. Apertures 48 may be represented by a single, large aperture 48 or a few that extend substantially across the majority of the insert 34.

By whatever mode, the seal 40 seats against the insert 34 in order to seal the liquid 20 in the container 12 away from the cavity 112. Thus, the cavity 114 occupying most of the volume of the container 12 contains the bulk of the liquid 20, such as a flavored, food-grade oil.

In operation, the shaft 44 or pedestal 44 operates to engage the cap 16, as the cap 16 is threaded down to seal the container 12. As the cap 16 contacts the shaft 44, the shaft 44 drives the backer 42 and seal 40 away from the insert 34. Thus, the apertures 48 become accessible to the cavity 114. Accordingly, tilting or upending (turning upside down) the container 12 and cap 16 will pass liquid 20 around the seal 40 and through the apertures 48 into the cavity 112.

A pill 18 placed on top of the insert 34 before applying the cap 16 is captured inside the cavity 112. Upending, shaking, or otherwise urging the liquid 20 to pass through the apertures 48 into the cavity 112 results in coating 20 the pills 18.

Following coating 20 by upending or shaking, the system 10 may be righted to the illustrated position. The system 10 may actually be set onto a supporting surface, such as a counter, table, desk, stand, or the like. Liquid 20 captured or present within the cavity 112 may thereby pass back through the apertures 48 into the cavity 114 of the container 12.

A user may elect to set a day's supply of pills 18 into the cavity 112 and coat them 20. Thereafter, a user may wait a short period of time, or an extended period of time, including all day. Thus, time provides the opportunity for any excess residual amount of the liquid 20 to pass back through the apertures 48 into the cavity 114 of the container 12. At a time selected to administer a pill 18 or the pills 18, a user may remove the cap 16 from the top of the container 12. The rising cap 16 thereby releases the shaft 44 to rise in response to the force applied by the bias 46 or spring 46. This urges the backer 42 upward.

Together, the insert 34, backer 42, and seal 40 may be thought of as a valve 116. In fact, the shaft 44 may be considered part of the valve 116. In actual operation, the insert 34 operates as the receiver or seat 34 that the seal 40 seals against. Thus, in one respect, the entire insert system 34 may be considered to include the shaft 44, backer 42, and seal 40 as a valve system 34.

By other definitions, the valve 34, 116 closes, sealing the apertures 48, and thus containing liquid 20 below the valve 34, 116.

With the cap 16 removed, a user may simply hold the container 12 and pour a pill 18 or multiple pills 18 directly into the mouth of the user to be swallowed.

The presence of oil against the liquids (e.g., saliva) in the alimentary tract of a user provides a reduction of friction. For example, typically, a pill 18 of whatever devising, as discussed above, will typically have excipients. Excipients involve any number of inactive ingredients whose purposes may be to aid processing, a feeding of materials through presses, may aid in release of pills 18 from a press, may contain flavored shells or layers to make them more palatable or obscure inherent flavors, or the like. Excipients often are water soluble. For example, corn starch is a common excipient as a binder. Such excipients are soluble in water, resulting in sticking and swelling in the throat.

In fact, most medicaments 18 are engineered to be water soluble and to dissolve or dissociate in the digestive tract. Problematically, in the thickened fluids of the mouth and esophagus, it is common for excipients in the outside materials of a pill 18 to partially dissolve in saliva or along the mucosal membranes of the esophagus and adhere thereto.

By introducing oil over the outside surface of a pill 18, two functions may be accomplished. Any essential oil flavoring, such as a citrus flavor (e.g., lime, lemon, orange) or a berry or other fruit flavor, may be dissolved within the oil. Meanwhile, any food-grade oil whether from corn, safflower, canola, olives, or the like may be used. In fact, a mineral oil may be used. However, food-grade oils tend to be the more palatable. Notwithstanding their biodegradability, food-grade oils will typically have a shelf life sufficient to be practical. In contrast, mineral oil may not biodegrade readily.

Thus, a user may grasp the container 12, absent the cap 16, and pour or toss one or more pills 18 resting on the insert 34 directly into the mouth. There need be no contact with fingers. A user may reach with fingers and withdraw a pill 18 from the top of the insert 34, but there is no requirement to do so. Thus, oil is retained and restrained within the cavity 114 of the container 12 except when needed to enter into the cavity 112 to coat a pill 18 therein. One may think of the insert 34 in this illustrated embodiment as constituting the basket 50. Various options for the baskets 50 may improve operation thereof.

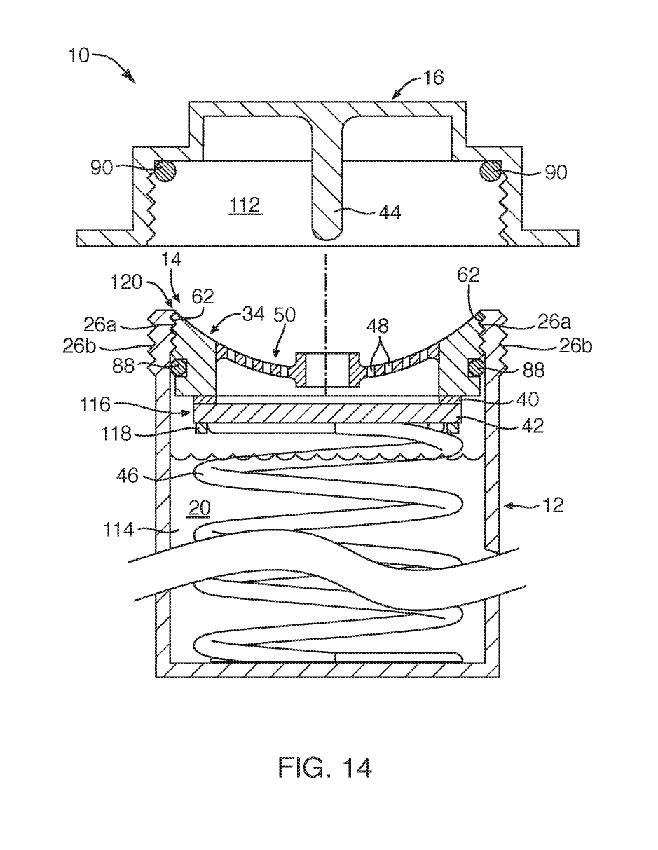

Referring to FIG. 14, in yet another alternative embodiment, a cap 16 may be provided with a shaft 44. Accordingly, the valve 116 need only have a foot 118 or rim 118 fitted inside, outside, or otherwise to move with the top end of the spring 46 as a coil spring 46. It may be molded, fitted, snapped or otherwise fitted to the diameter or other dimension of the spring 46. In this way, the backer 42 may be aligned with the spring 46. In fact, as a coil spring 46, an inside diameter may fit over the rim 118, provided with a detent or rise at which point the outer diameter of the rim 118 may slightly enlarge. Similarly, the inner diameter of the rim 118 may also have or alternatively have a detent such as a slightly smaller diameter region.

The spring 46 may thus distort slightly to fit over a detent on the outside surface or inside a detent on the inside surface of the rim 118. In this way, the spring 46 may be engineered to secure, albeit removably, to the backer 42. The seal 40 may be glued, riveted, stapled, pinned, engaged by detent, or the like. For example, a detent pedestal or pin rising from the center of the backer 42 may stretch the seal 40 about a hole in the center of the seal 40 in order to render the seal 40 a washer 40 that snaps over the detent pedestal extending upward on the backer 42. Similarly, an aperture 48 in the backer 42 may receive a button or stub near the center of the seal 40 to snap the stub into the aperture 48 on the backer 42.

In the illustrated embodiment, the basket 50 is illustrated as having curvature. This urges all oil 20 that passes into the upper cavity 112 to pass back down to a lowest point in the basket 50, and thereafter through the apertures 48 into the lower cavity 114. FIG. 13 illustrates a “closed” configuration. FIG. 14 illustrates an “open” configuration. However, the shaft 44 and backer 42 may be oriented in either direction.

Likewise, a basket 50 may be of any suitable shape, whether conical, curved, trapezoidal, or the like. An advantage to sloping the upper surface of the insert 34 downward toward the center is that the area is minimized in which the oil collects. This urges against surface tension maintaining oil 20 or other liquid 20. Oil tends to pass downward through the apertures 48 into the cavity 114 of the container 12.

The embodiments of FIGS. 13 and 14 may be combined in various of their configurations, or have an exchange of components. Thus, alternative embodiments of components and relationships are illustrated in these two configurations, one being closed and one being open, one having a shaft 44 secured to the backer 42, and one having a shaft 44 secured to the cap 16, one having a flat or straight top surface of the insert 34, and one having a sloped top surface, and so forth.

Certain advantages of the configuration of FIGS. 13 and 14, or some assembly using some selection of components therefrom, is an ease of manufacture. On the one hand, the spring 46 in the liquid 20 is not particularly sophisticated in appearance. In fact, one benefit to a clear container 12 is an ability to see what the level of liquid 20 is, and when replenishment is necessary. If the container 12 is instead opaque, the spring 46 is not visible anyway. Such a system 10 is comparatively simple to manufacture and assemble. For example, molding threaded components is well known in the art, and such components may be removed from a mold by spinning of the mold or the component with respect to the other.

Thus, one will note that all of the components may be built in a two-piece mold, so long as threaded rotations are available for various inserts 34 or core pulls. Meanwhile, assembly is rather straightforward, with the spring 46 snapped onto a backer 42, and placed in a container 12, to be held in place by an insert 34 threaded into the opening region 120 or neck 32 of the container 12. The seal 40 may be snapped or otherwise secured onto the backer 42 before the backer 42 is clipped onto the spring 46.

After being dropped into the container 12, the backer 42 and spring 46 may have an equilibrium position that is higher than the ultimate position of the bottom surface of the insert 34. Thus, as the insert 34 is threaded down into the container 12, the insert 34 develops a force against the seal 40, and against the force of bias in the spring 46. Thereby, the sealing force necessary to urge the seal 40 into liquid-proof contact against the insert 34 results.

In general, seals 88, 90 may be formed in any suitable manner, such as forming a gasket, an ‘O’ ring 88, 90, or the like. In the illustrated embodiments, each ‘O’ ring may be fitted in a receiving channel in either component involved with a seal 88, 90. That is, in standard ‘O’ ring 88, 90 configurations, the ring itself operates to fit within a receiving slot or groove in such a manner that it extends outside the groove. A contacting surface pressing against an ‘O’ ring 88, 90 thereby compresses the ‘O’ ring 88, 90 back into its receiving channel or groove. Thus, applying pressure against the contacting face, as well as against all three surfaces of the groove. In this way, sealing may be accomplished. Accordingly, ‘O’ rings 88, 90 may be placed in any position that they may be suitably fitted, having a groove cut into one surface of any shape, and having a second surface in matching contact therewith. Accordingly, either surface may receive the groove and the ‘O’ ring 88, 90, and the other may be the pressing surface. ‘O’ rings' 88, 90 locations may thus be a matter of manufacturing preference. Meanwhile, manufacturability, mold design, and the like may control the locations, orientations, and their respective surface for receiving any particular ‘O’ ring as a seal 88, 90.

As a practical matter, a container 12 may be of any suitable shape, may be threaded inside or outside the neck 32 thereof, and so forth. The closure assembly 14 may be built from any suitable number of components. The insert 34 as a portion of the closure assembly 14 may be threaded, interference fit, glued, retained by a detent, or installed and secured in any suitable method known in the art.

It is advisable to maintain a liquid-proof seal between the insert 34 and the neck 32 of a container 12. It also good operational practice to provide a seal between the regions of the first cavity 114 or second cavity 112 and the exterior of the cap 16 and the container 12. With oils 20 as the liquid 20 of choice, the tendency of oils 20 to creep along surfaces and by capillary action through crevices may be problematic. Accordingly, as illustrated in various embodiments, an ability of the container 12 and cap 16 to drain liquids 20 always back toward the apertures 48 and into the cavity 114 of the container 12 is highly desirable.

To that end, certain excipients may be added to the oil 20 or other liquid 20 in order to decrease its viscosity. For example, certain alcohols may be miscible with oils 20. Accordingly, addition of alcohols may thin the oils 20 in order to decrease capillary action, decrease viscosity, encourage flow back toward the cavity 114, and discourage clinging or beading above the insert 34 and other portions of the closure assembly 14.

The present invention may be embodied in other specific forms without departing from its purposes, functions, structures, or operational characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus to administering a pill to a user, the apparatus comprising:
a vessel comprising a container and a cap, the container characterized by a first volume defined by a floor, an opening, and a wall extending between the floor and the opening, and a the cap characterized by a second volume sealingly securable to the opening;
a valve connecting the first volume to the second volume in response to the cap in a first, closed position with respect to the container, and closing the second volume away from the first volume in response to removal of the cap from the container; and
an actuator, operable by the cap to hold the valve open to connect the first volume to the second volume, when the cap is in the first, closed position, and operable to release the valve into a closed position, when the cap is in the second, open position.

2. The apparatus of claim 1, further comprising a liquid disposed within the first volume.

3. The apparatus of claim 1, further comprising a perforated region effective to hold the pill in the second volume and away from the first volume while passing the liquid from the first volume into the second volume.

4. The apparatus of claim 3, wherein the valve further comprises a seal and an actuator, the seal being movable by the actuator between a closed position, separating the first volume from the second volume, and an open position, connecting the first and second volumes.

5. The apparatus of claim 4, wherein the actuator is operably connected to move the seal in response to movement of the cap.

6. The apparatus of claim 11, wherein the valve is contained in an insert disposed within the vessel.

7. The apparatus of claim 6, wherein the insert is secured within the container against removal.

8. The apparatus of claim 7, wherein the container has a base effective to maintain the vessel in an upright orientation on a supporting surface.

9. The apparatus of claim 8, wherein the insert contains the perforated region and the valve.

10. The apparatus of claim 9, wherein the insert contains a cradle region capable of holding the pill when the vessel is in an upright orientation, and of releasing the pill into the mouth of the user without releasing the liquid from the container in a tilted orientation angled away from the upright orientation.

11. A method of administering a pill to a user, the method comprising:
providing a vessel comprising a container defining a first volume and a cap defining a second volume adjacent the first volume;
providing an insert within the vessel and operable to selectively seal and open a path between the first volume and second volume;
providing a liquid in the container;
placing a pill in the insert;
moving a portion of the liquid between the first and second volumes by re-orienting the vessel;
draining an excess amount of the liquid from the insert; and
retrieving by a user directly, the pill, coated with a film of the liquid.

12. The method of claim 11, wherein:
moving a portion of the liquid further comprises opening a path between the first and second volumes by closing the container with the cap; and
draining further comprises orienting the container in an upright position.

13. The method of claim 11, further comprising delivering the pill to the mouth of a user without the use of digits of the user.

14. The method of claim 11, further comprising:
swallowing, by the user, the pill, in reliance on immiscibility of the liquid with respect to the alimentary tract of a user.

15. The method of claim 11, further comprising:
automatically actuating a valve opening the first volume to the second volume by closing the cap on the container.

16. The method of claim 11, wherein coating the pill comprises upending the vessel.

17. The method of claim 16, wherein draining further comprises standing the vessel upright to drain excess quantities of the liquid from the second volume.

18. The method of claim 11, further comprising:
closing the valve between the container and the cap by opening the cap with respect to the container;
administering the pill directly to the mouth of a user with no intervening contact between the user and the pill.

19. A method of administering a pill to a user, the method comprising:
providing a vessel comprising a container and a cap, the container characterized by a first volume defined by a floor, an opening, and a wall extending between the floor and the opening, and a second volume defined by a cap sealingly securable to the opening;
providing a valve connecting the first volume to the second volume in response to the cap in a first, closed position with respect to the container, and closing the second volume away from the first volume in response to removal of the cap from the container;
providing a liquid in the first volume;
placing a pill in the second volume;
coating the pill with the liquid by placing the cap on the container;
draining an excess amount of the liquid from the second volume into the first volume; and
providing access to the pill, coated by the liquid, by removing the cap;

20. The method of claim 19, wherein;
coating further comprises moving the vessel to urge a portion of the liquid from the first volume to the second volume;
draining further comprises enabling passage of the excess amount into the first volume by standing the vessel upright with the cap in the first, closed position; and
providing access comprises exposing the pill to a mouth of a user without contacting the pill with digits of the user.
